(19) United States
(12) Patent Application Publication
(10) Pub. No.: US 2025/0170942 A1
(43) Pub. Date: May 29, 2025

(54) BULK LIFT AND DUMP SYSTEM

(71) Applicant: Tim Bonerb, North Hampton, NH (US)

(72) Inventor: Tim Bonerb, North Hampton, NH (US)

(21) Appl. No.: 18/918,788

(22) Filed: Oct. 17, 2024

Related U.S. Application Data
(63) Continuation-in-part of application No. 18/522,314, filed on Nov. 29, 2023, now Pat. No. 12,145,797.

(51) Int. Cl. B60P 1/28; B60P 1/22

(52) U.S. Cl. CPC B60P 1/286; B60P 1/22

(57) ABSTRACT

A detachable loading device mounted on a cargo container of a vehicle for handling, lifting and dumping bulk materials such as grass clippings, soil and other bulk materials.

### CROSS-REFERENCE TO RELATED APPLICATIONS

This application is a continuation-in-part of prior application Ser. No. 18/522,314, filed Nov. 29, 2023.

### BACKGROUND OF THE INVENTION

### 1) Field of Invention

The concept concerns the manual moving of bulk materials such as grass clippings, soil, stone, mulch etc., up and into a cargo vehicle with a generally open top such as a dump truck, dump trailer, dump insert, flatbed truck and/or flatbed trailer, shipboard container, storage bin, etc., for temporary storage and/or transport.

### 2) Description of Related Art

After a lawnmowers' grass collection containers are full from mowing, the operator drives the mower to the cargo vehicle whereby the operator separates the grass clippings from the mower and then lifts each collection container over the top of a cargo container and dumps the grass clippings or other bulk materials onto the cargo container's floor. Typically, the operator loads the cargo container from both sides (driver's side and passenger side) as well as from the back tail gate area to create a level and balanced load.

### BRIEF DESCRIPTION OF DRAWINGS

FIG. 1 is a side view of dump truck equipped with lift assembly mounted on shoulder side of truck with lift container collapsed and stowed for transport above dump container.

FIG. 2 is a side view of dump truck with lift container collapsed and positioned half way up lift rack of lift assembly.

FIG. 3 is a side view of dump truck with lift container collapsed and positioned near the bottom of lift tracks of lift assembly.

FIG. 4 is a side view of dump truck with lift container unfolded, filled with bulk material and positioned on lift assembly resting on the ground.

FIG. 5 is a side view of dump truck with lift container filled with bulk material and positioned near top rail of dump body secured to tracks of lift assembly.

FIG. 6 is an end view of dump truck with lift container unfolded and filled with bulk material positioned and connected to bottom of tracks of lift assembly.

FIG. 7 is an end view of dump truck with lift container filled with bulk material and positioned half way up tracks and lift system.

FIG. 8 is an end view of dump truck with empty lift container positioned at top of tracks while bulk material is loaded into dump body via lift system.

FIG. 9 is an end view of dump truck with empty lift container remaining at top of tracks while bulk material rests on floor of dump body.

FIG. 10 is an end view of dump truck partially filled with bulk material while tracks of lift assembly remain inside the mirror on the cab of dump truck.

FIG. 11 is an end view of dump truck with lift assembly stowed on top of and within the width of the dump body.

FIG. 11a is an end view of a dump body equipped with a curved guide rail for transitioning the lift tracks from a horizontal to a vertical position.

FIG. 11b is an end view of a lift system utilizing a guide rail cart mounted on its curved guide rail.

FIG. 11c is an end view of a guide rail cart secured to the guide rail and to the a lift track.

FIG. 11d is an end view of the roller assembly attached to a curved guide rail and to a roller pipe on a dump body.

FIG. 11e is an end view of the roller pipe secured to a dump body via an end plate with a guide rail cart mounted on a guide rail which is secured the roller pipe via dump body roller assembly.

FIG. 11f is a side view of a dump body with a roller pipe secured to dump body with two end plates so that trolley frame equipped with a lift system can move laterally.

FIG. 11g is a top view of lift system equipped with a motorized chain system to move lift tracks from a horizontal position to a vertical position.

FIG. 11ga is a top view of a lift system equipped with a motorized linear actuator assembly which move the guide rail cart back and forth on the set of guide rails.

FIG. 11h is a top view of a lift system equipped with a motorized chain system to raise and lower the lift container via the set of lift tracks.

FIG. 11i is a top view of a motorized chain system which moves the lift system laterally on top of each side of the dump body.

FIG. 11j is an view with a lift system in a vertical position utilizing a lift platform (equipped with proximity switches) for raising and lowering piece goods cargo to and from the ground to the dump body.

FIG. 11k is an end view of a lift system equipped with a straight set of lift tracks with a lift container that is emptied via a hydraulic cylinder for dumping.

FIG. 12 is an end view of lift assembly moved towards shoulder side of dump truck while remaining connected to trolley frame of lift assembly.

FIG. 13 is an end view of lift assembly angled downward while remaining connected to trolley frame mounted to rails of dump body prior to use.

FIG. 14 is an end view of dump truck with lift container lowered to the ground via tracks of lift assembly positioned for loading.

FIG. 15 is an end view of dump truck equipped with lift assembly having track extensions added to tracks.

FIG. 16 is a top view of dump body on dump truck with lift frame assembly stowed on trolley frame near the end of dump body.

FIG. 17 is a top view of dump body of dump truck with lift assembly equipped with trolley frame moved towards the other end of dump body via the trolley frames wheels running on top rail of dump body.

### DETAILED DESCRIPTION

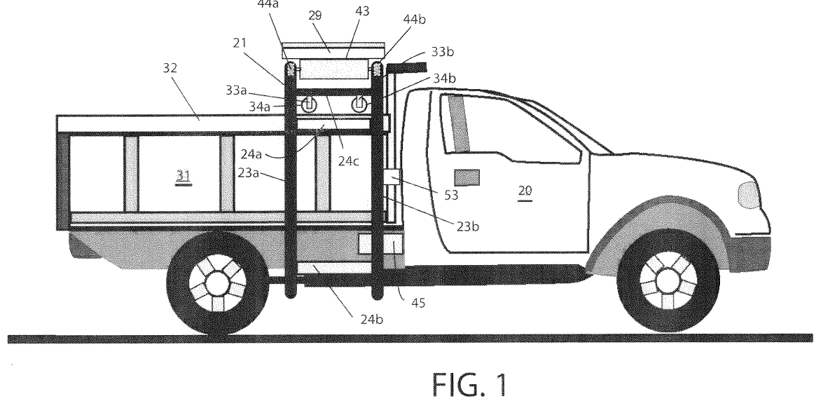

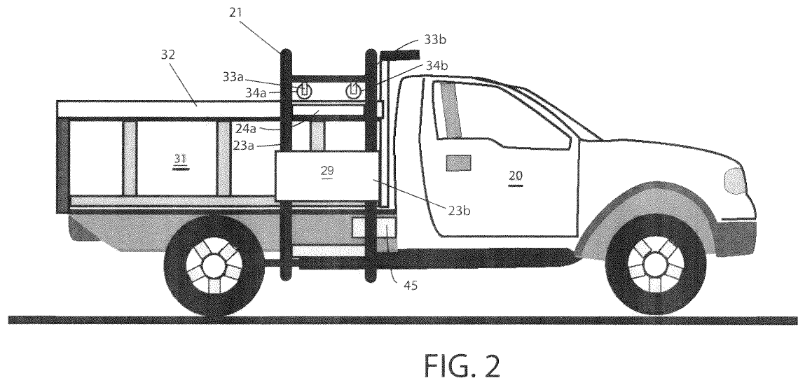

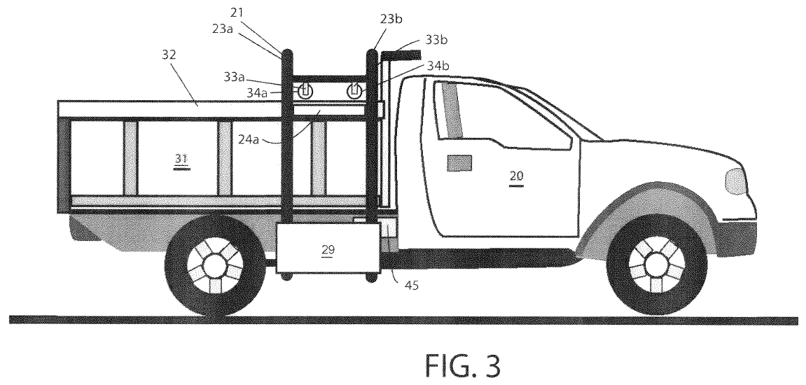

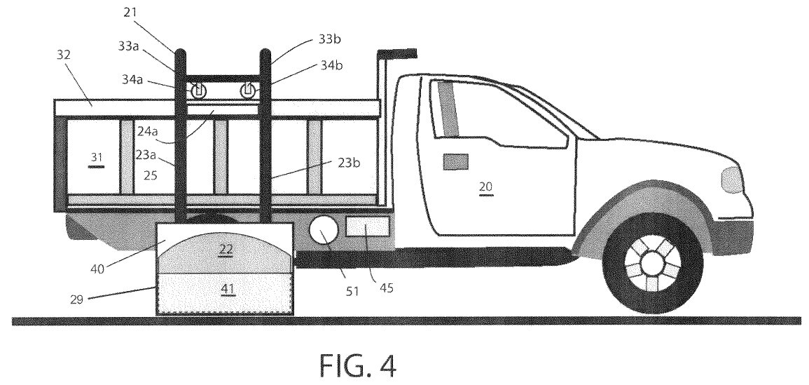

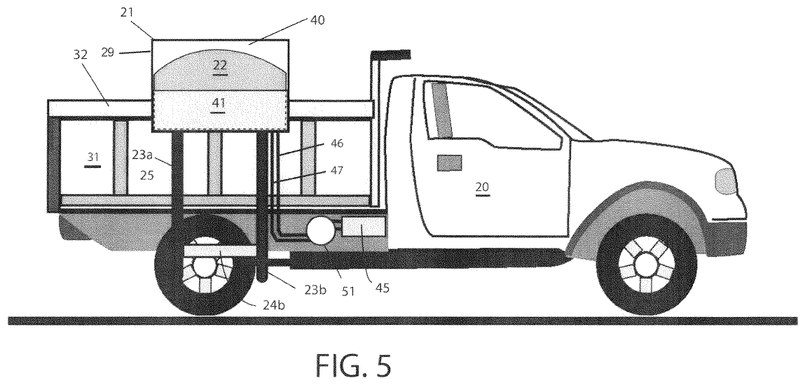

FIGS. 1, 2, 3, 4 and 5 are side views of a dump truck 20 equipped with a lift assembly 21. In FIG. 1, the lift assembly 21 is equipped with a collapsed lift container 29 for transport at top of lift tracks 23a and 23b attached a top rail 32 of a dump body 33. Lift assembly 21 is secured to the dump body 31 via a lift assembly lock 53 when not in use. Also shown, the lift container 29 secured to the lift tracks 23a and 23b via a roller beam 43 and rollers 44a and 44b. To provide movement of the lift assembly 21 along the top rail 32 of the dump body 31, wheel brackets 33a and 33b are equipped with wheels 34a and 34b are secured to a cross support 24c of the lift frame assembly 21. Lift tracks 23a and 23b are about 2 [symbol] wide which remain inside of a cab mirror 57 (not shown) that is suitable and legal for operation on most roads in the world. In FIG. 2, the lift container 29 of the lift assembly 21 mounted on the dump body 31 of the dump truck 20 is lowered on the rails 23a and 23b in a collapsed configuration positioned about half way down the lift tracks 23 and 23b. Also shown is the lift assembly 21 with a lift assembly lock 55 (not shown) removed to provide more filling locations along the side of the dump body 31. In FIG. 3, the lift container 29 remains in a collapsed configuration at bottom of the lift tracks 23a and 23b of the lift assembly 21. The lift container 29 may be provided in a rigid configuration (not shown) as well as a collapsed configuration. In FIG. 4, the lift assembly 21 has been moved towards the center of the dump body 31 via the wheels 34a and 34b on the top rail 32 of the dump body 31. As shown, the lift container 29 is opened with a back wall 40 and a lift container front wall 41 providing about 2 to 3 feet of space filled with about 200 pounds of a load grass clippings 22. When a hydraulic pump 45 is used to power the lift container 29 up and down the lift tracks 23a and 23b, it can be used in conjunction with a hydraulic hose reel 51 and hydraulic hoses 46 and 47 (not shown) to provide adequate movement of the lift assembly 21 along the top rail 32 of the dump body 31. The hydraulic hoses 46 and 47 (not shown) can be equipped with quick-disconnect fittings (not shown) when the lift assembly 21 is not in use. Other power systems such as winches, linear actuators, gear motors, air cylinders, rotary actuators, chains and sprockets, cable and pulley assemblies, etc., can be used in place of the hydraulic pump 45. In FIG. 5, the lift container 29 filled with the grass clippings 22 has been elevated towards top end of the lift tracks 23a and 23bh keep of the lift assembly 21.

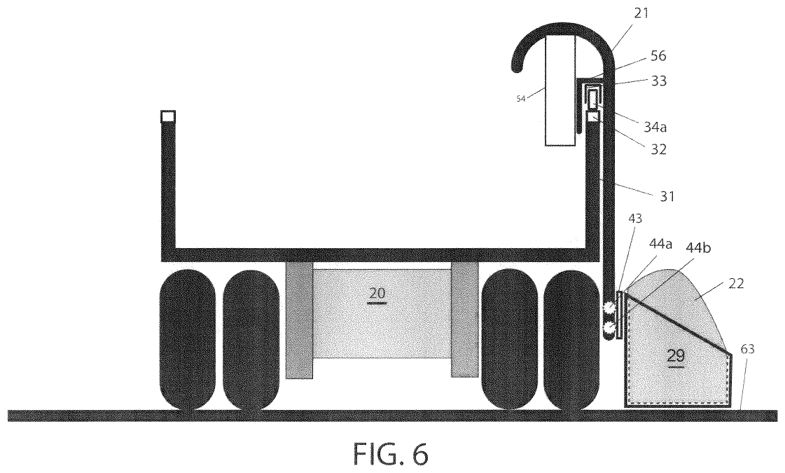

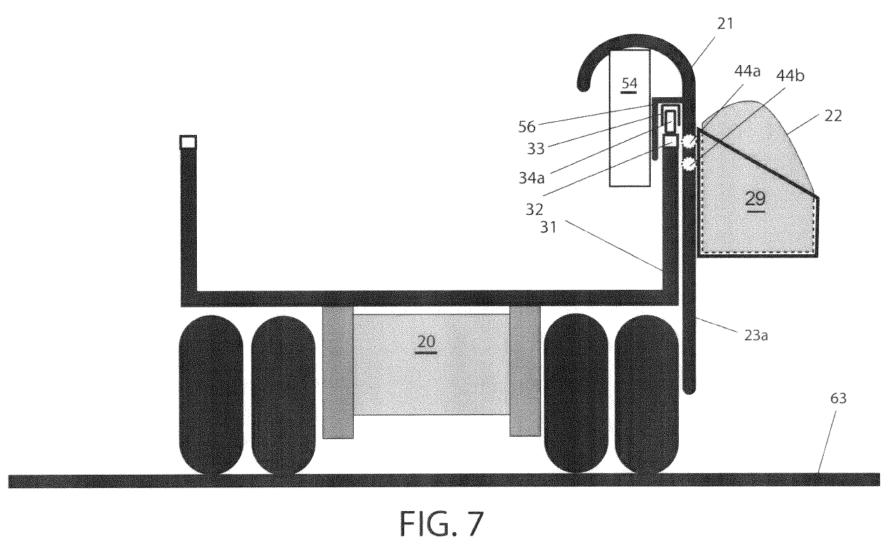

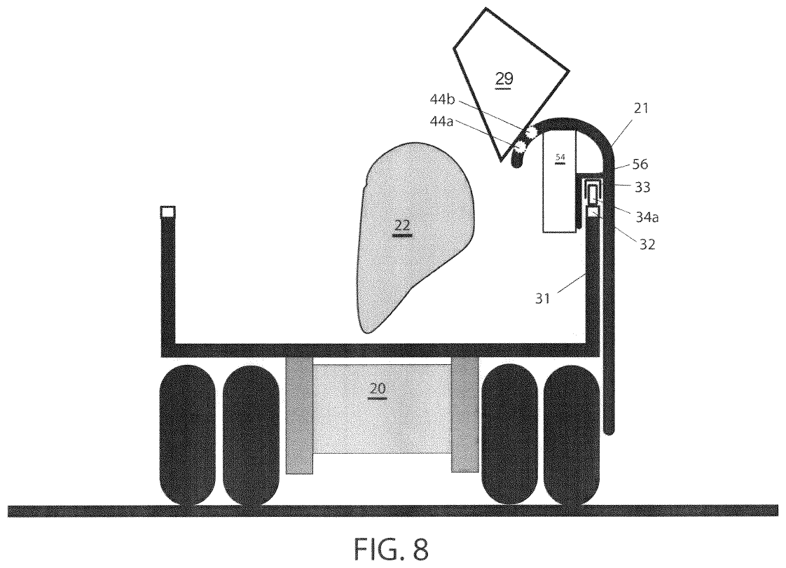

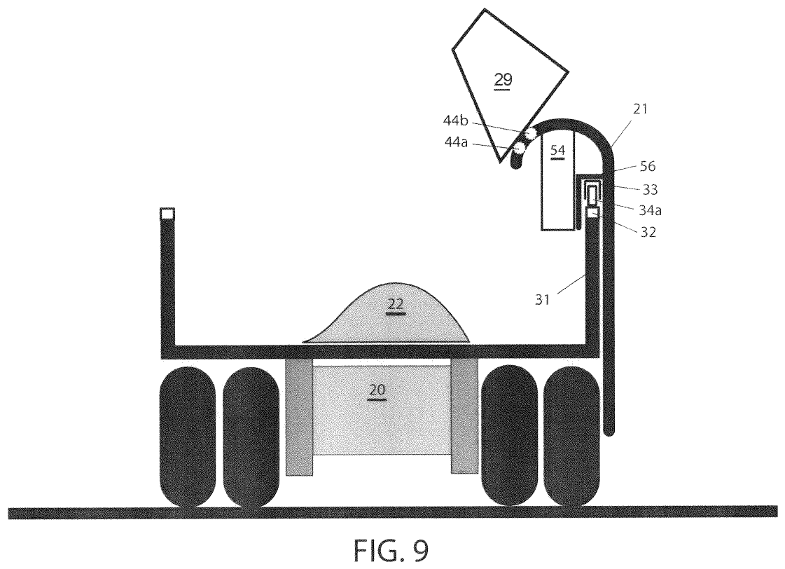

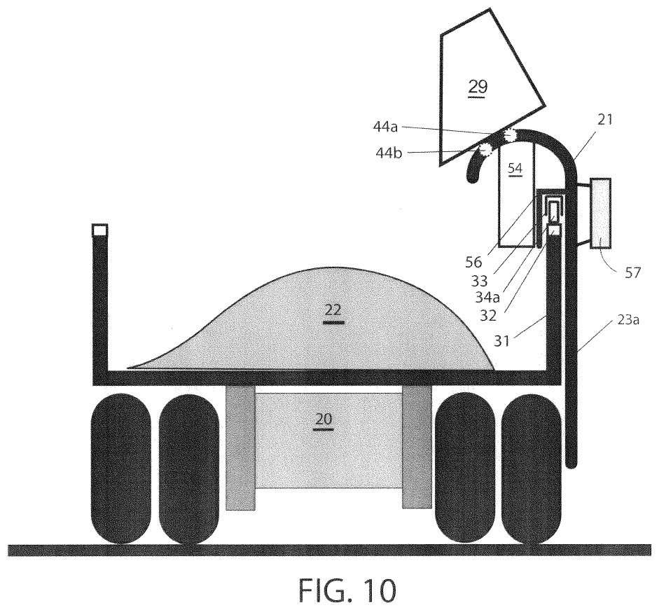

FIGS. 6, 7, 8, 9 and 10 are end views of the lift assembly 21 attached to the dump body 31 of the dump truck 20 with the lift container 21 at different height levels of operation during the loading process. In FIG. 6, the lift assembly 21, which can be quickly and easily detached from and/or re-attached to the dump body 31 by positioning a collar bracket 56 of the lift assembly 21 over the top rail 32 via lifting and lowering the lift system 21 via an overhead lifting equipment (not shown), is shown with the lift container 29 filled with the grass clippings 22 while resting on ground 63. Also shown is a control enclosure 54 secured to the lift assembly 21 and/or the collar bracket 56, which houses the hydraulic pump 45 (not shown), a cable and pulley assembly 75 (not shown) and other control and lift components (not shown). Other power systems and devices such as linear actuators, rotary actuators, air cylinders, load cells, scales, winches and other lifting and control devices may be used instead of hydraulics, grouped with the hydraulic pump 45. Attached to the collar bracket 56 is a wheel bracket 33a and a wheel 34a which allow the lift assembly 21 to be rolled along the top rail 32 of the dump body 31 as desired during the loading operation. In FIG. 7, the lift container 29. filled with the grass clippings 22 has been moved upward on the lift tracks 23a and 23b (not shown) via a lift cable 55 (not shown) on the lift assembly 21. In FIG. 8, the lift container 29 is empty and positioned at top end of the lift assembly track 21 with the load of grass clippings 22 discharged into the dump body 31 of the dump truck 20. In FIG. 9, the grass clippings 22 are piled on floor of the dump body 31 while the lift container 20 remains in a locked and stowed position before a truck 20 can move. In FIG. 10, the grass clippings 22 have been dumped onto the floor of the dump body 31. Also shown is the lift track 23a, which is about 2 inches wide, that remains against side of the dump body 31 and within the of outer width dimension of the mirror 57 on the truck 20 (not shown) to meet the highway vehicle width limit of most countries around the world.

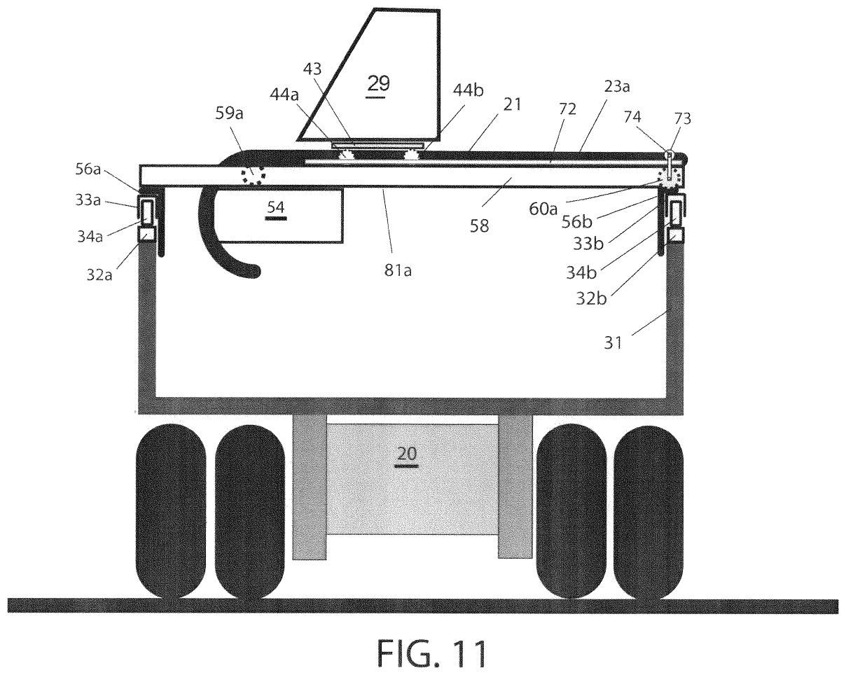

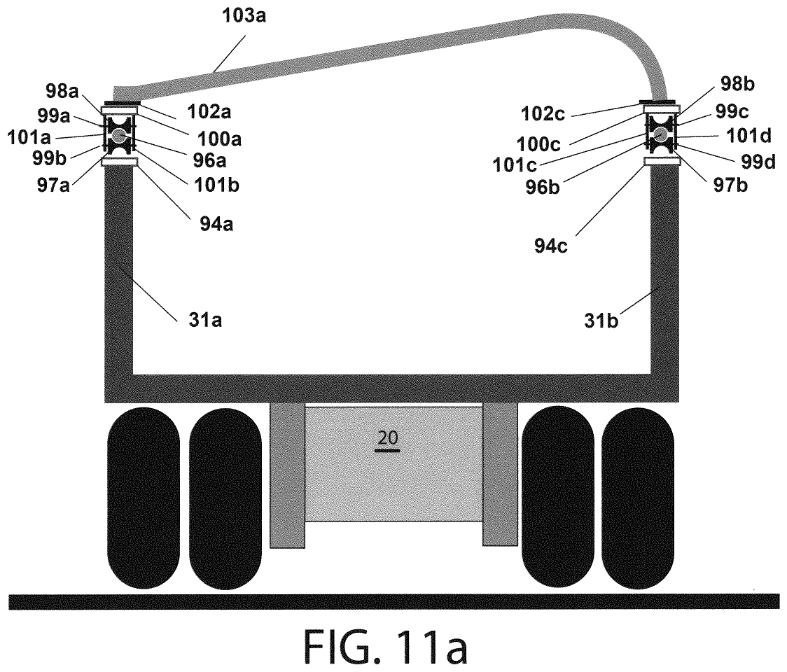

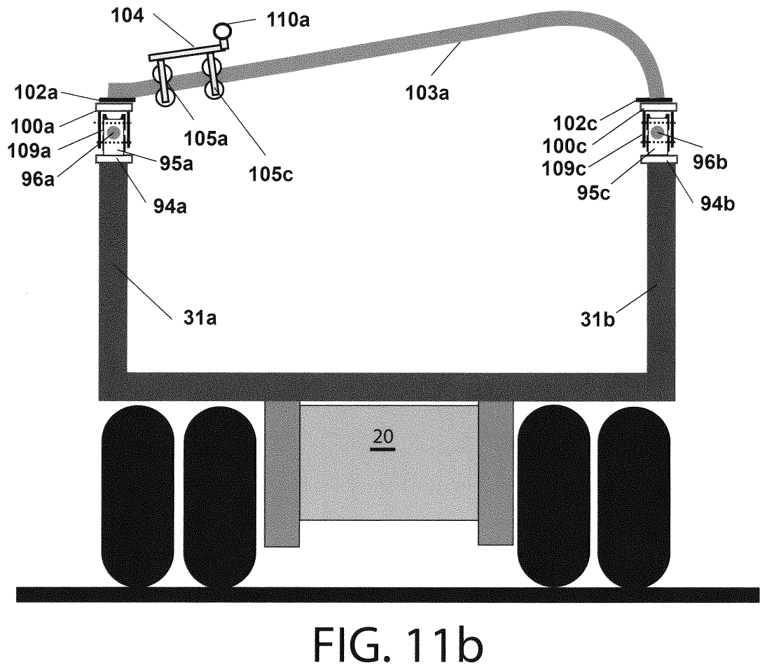

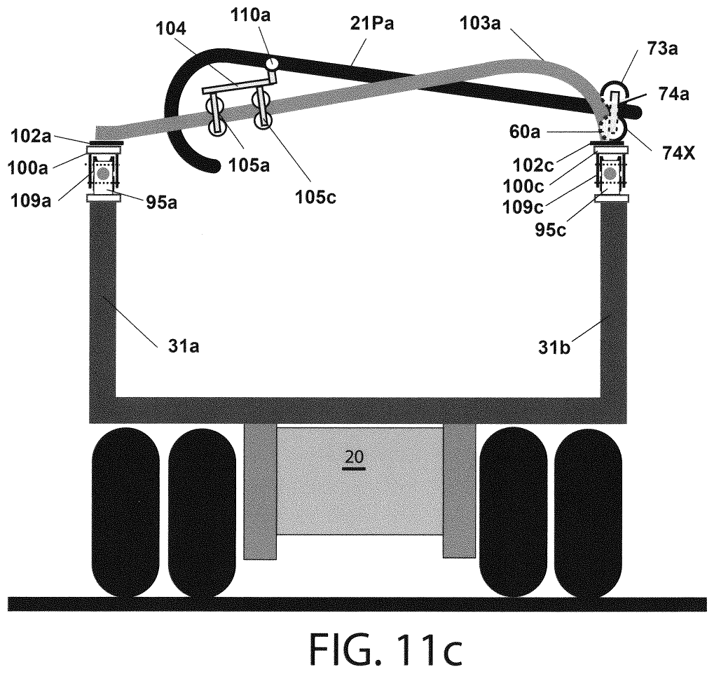

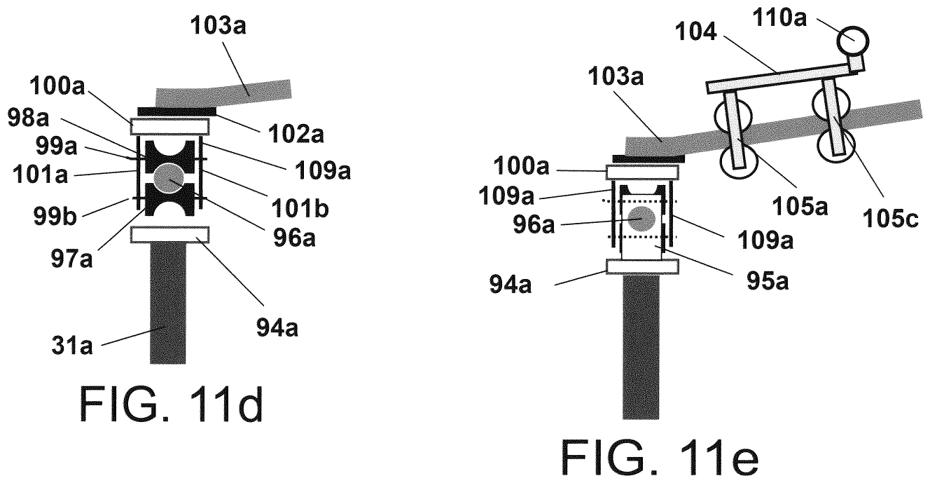

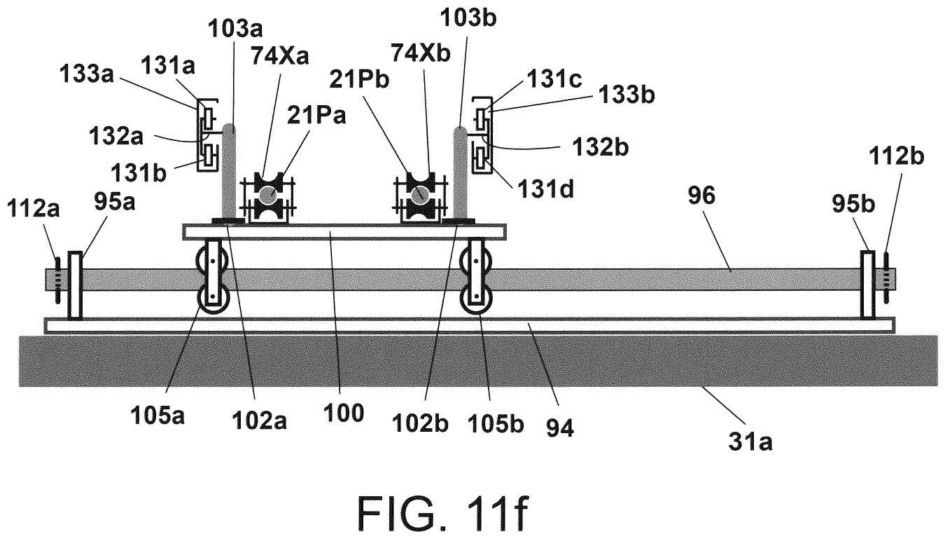

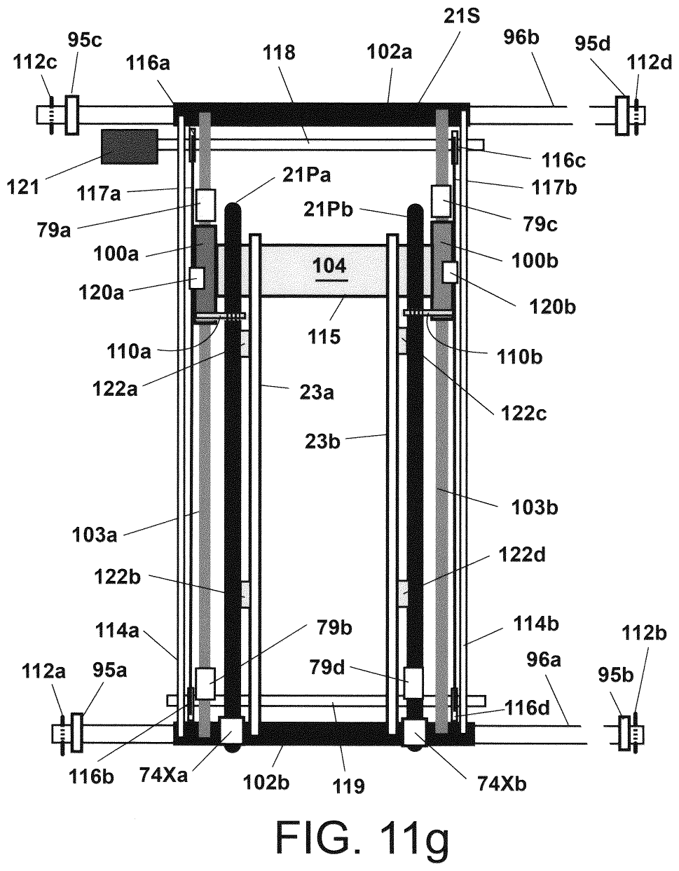

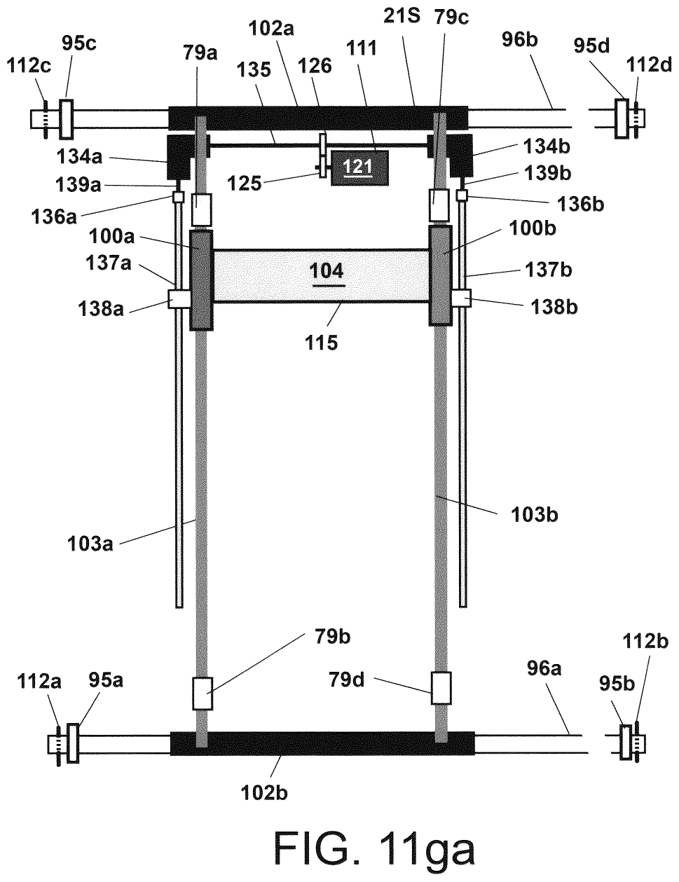

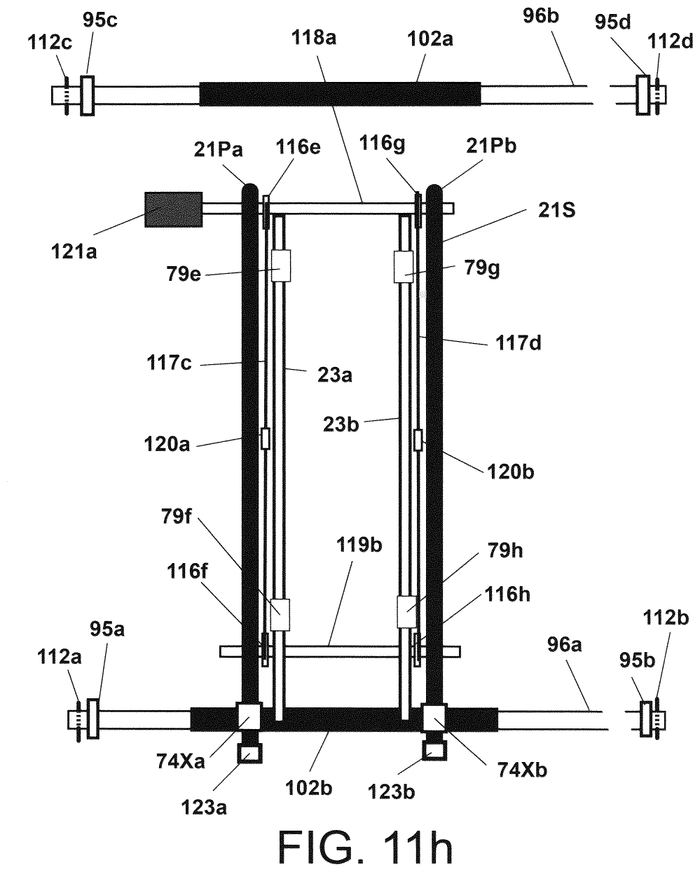

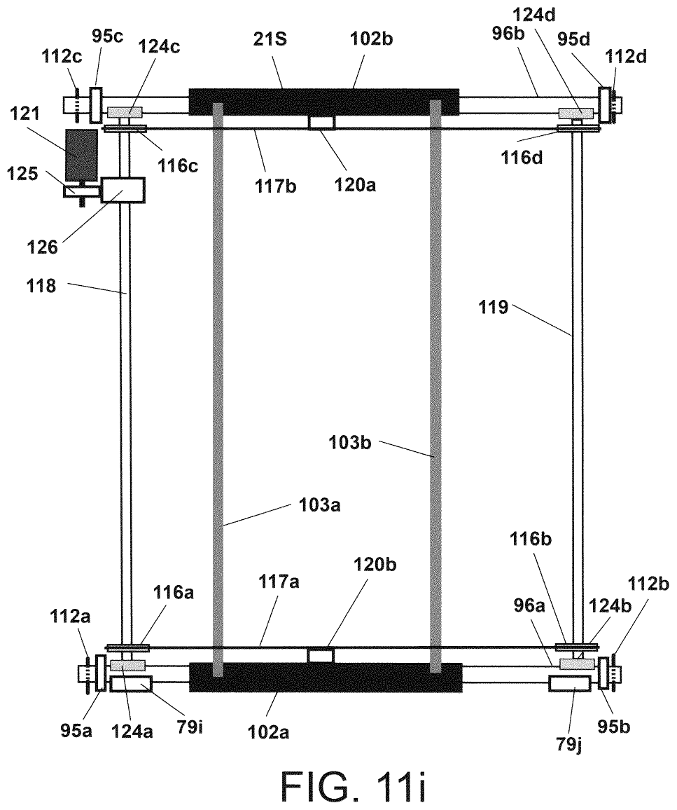

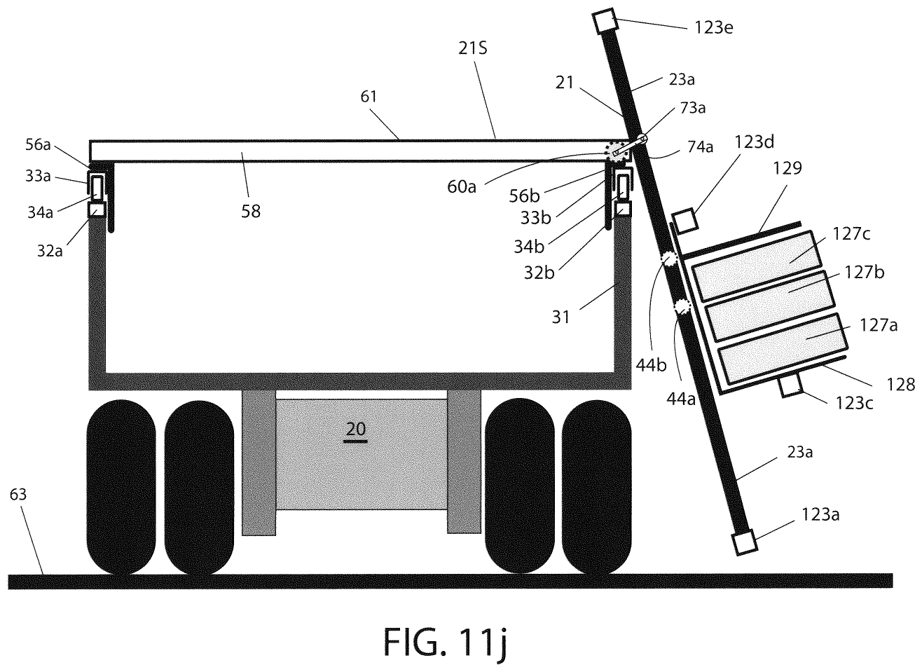

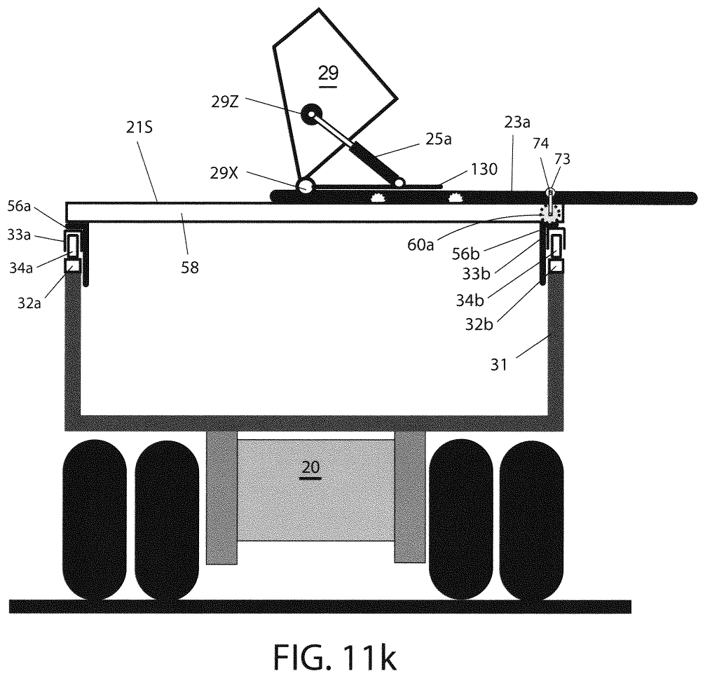

FIGS. 11A, 11b and 11c are end views of truck 20 equipped with dump body 31 showing guide rail 103a extending from the top of dump body side wall 31a to the top of dump body side wall 31b. Guide rail 103a and 103b (not shown) provide a curved transition path to move the lift assembly 21 (not shown) from a horizontal position on top of the dump body 31 to a more vertical position to the right side of dump body 31 for accepting loaded of bulk material and or other materials. Also, to provide lateral movement of guide rails 103a and 103b (not shown) from the front of the dump body 31 to the rear of dump body 31, guide rails 103a and 103b (not shown) are fixed to guide rail base plates 102a and 102b, as well as 102c and 102d (opposite side) which may be bolted to trolley frames 100a and 100b. With respect to guide rail 103a, trolley frames 100a and 100b are equipped with side flanges 101a and 101b above dump body side wall 31a as well as side flanges 101c and 101d above dump body side wall 31b. As shown, side flanges 101a and 101b, fixed to trolley frame 100a, hold top roller 98 and bottom roller 97a in place via axles 99a and 99b respectively which in turn may roll along roller pipe 96a. Likewise, side flanges 101c and 101d, fixed to trolley frame 100c, hold top toller 98b and bottom roller 97b via axles 99c and 99d respectively which in turn may roller along roller pipe 96c. Directly below bottom rollers 97a and 97b are dump body base plates 94a and 94b, which are fixed (welded and/or bolted) to the dump body sides 31a and 31b respectively. Please note that guide rail 103b (not shown) is configured in the same manner as guide rail 103a. In FIG. 11b, notice that roller pipes 96a and 96b are held in place on dump body 31 via dump body end plates 95a and 95b respectively, which may be welded to dump body base plates 94a and 94b. Also notice that guide rail cart 104 is attached to guide rails 103a and 103b (opposite side) via cart roller assemblies 105a and 105c, and 105b and 105d (opposite side) and cart roller assemblies 105c and 105d (opposite side). In FIG. 11c, the left end of lift frame posts 21Pa and 21Pb (opposite side) on attached to guide rail cart 104 via cart axles 110 and 110b (opposite side). In conjunction with cart axles 110a and 110b (opposite side), the right end of lift frame posts 21Pa and 21Pb (opposite side) are held between fixed rollers 60a and 60b (opposite side) and side rollers 73a and 73b (opposite side) via roller connectors 74a and 74b (opposite side). As guide rail cart 104 moves upward and follows guide rail 103a and 103b (opposite side), lift frame posts 21Pa and 21Pb (opposite side) will move from a generally horizontal position to a generally vertical position in a repeatable and more precise operation which can be performed manually by an operator or by an automatic, motorized system.

FIGS. 11d and 11e are more detailed side views of dump body roller assembly 109a, which provides lateral movement of guide rail 103a. In FIG. 11d, dump body roller assembly 109a is not attached to dump body 31a because dump body end plate 95a (not shown) is missing and not fixed to dump body base plate 94a. In FIG. 11e, dump body end plate 95a is fixed to dump body base plate 94a to hold roller pipe 96a in place while extending through matching hole in of dump body end plate 95a. For removal and/or installation of guide rails 103a and 103b (opposite side) from dump body 31, roller pipes 96a and 96b (opposite side) may be removed from dump body end plates 95a and 95b, 95c and 95d (not shown) to remove the lift system 21S from truck 20. Lift system 21S may be quickly and safely removed and/or reinstalled on dump body 31 (not shown) as desired depending on the different uses of truck 20.

FIG. 11f is a side view of a side of dump body 31a equipped with dump body base plate 94 with end plates 95a and 95b welded to it. Dump body base plate 94 may be fastened to and/or welded to the side of dump body 31a to hold it firmly in place. Notice roller pipe 96 passes through ends plates 95a and 95b and held in place via lock pins 112a and 112b. As shown, trolley frame 100 is secured to roller pipe 96 via dump body roller assemblies 110a and 110b as well as dump body roller assemblies 110c and 110d (opposite side). As shown, guide rails 103a and 103b are equipped with guide rail base plates 102a and 102b respectively so that guide rail base plates can be fastened to and their exact placement adjusted on trolley frame 100. Chain roller brackets 114a and 114b are secured to guide rails 103a and 103b respectively. One or more chain brackets 114 may be secured to each guide rail 103 to properly support and guide the path of chains 117a and 117b (not shown) are adjacent to the path of guide rails 103a and 103b for attachment to guide rail cart 104 (not shown). Please note that chain roller brackets 114a and 114b are located on guide rails 103 between the gap between cart roller assembly 105 (not shown) of guide rail cart 104. Sprockets 131a and 131b are freewheeling and secured to chain bracket 132a as are also freewheeling sprockets 131c and 132d which are secured to chain bracket 132b. Also shown are lift frame roller assemblies 74Xa and 74Xb secured to trolley frame 100 between guide rails 103a and 103b which hold lift frame posts 21Pa and 21Pb in place. Chain guards 133a and 133b may be added to chain brackets 132a and 132b respectively.

FIG. 11g is a partial top view of lift system 21S attached to roller pipes 96a and 96b. As shown, chain frames 114a and 114b and guide rails 103a and 103b are attached to guide rail base plates 102a and 102b respectively. Also shown are trolley frames 100a and 100b secured together via connector 115 so that guide rail cart 104 may slide back and forth on guide rails 103a and 103b. Notice that with so that axles 110a and 110b are attached to lift frame posts 21Pa and 21Pb. Notice that with axles 110a and 110b, which are fixed to guide rail cart 104, are attached to lift frame posts 21Pa and 21Pb so that the movement of chains 117a and 117b, which are secured to guide rail cart 104 via chain connectors 120a and 120b respectively, will control the movement of lift frame posts 21Pa and 21Pb. Also shown are limit switches 79a and 79b located on guide rail 103a as well as limit switches 79c and 79d located on guide rail 103b, that will limit the movement on of guide rail cart, especially if the lift system 21S is motorized. Notice that lift tracks 23a and 23b are fixed to lift frame posts 21Pa and 21Pb via lift track brackets 122a, 122b, 122c and 122d. Also shown are lift frame roller assemblies 74Xa and 74Xb, fixed to guide rail base plate 102b which hold lift frame posts 21Pa and 21Pb in place while they transition from a horizontal position to a more vertical position. Motor 121 and drive axle 118 are attached to the bottom of guide rails 103a and 103b. Chains 117a and 117b are located on sprockets 116a and 116c on drive axle 118 while sprockets 116b and 116d are attached to axle 119, which is freewheeling. Motor 121 may be a hydraulic motor or an electrical motor. While the average width of a dump body 31 (not shown) is 96″, lift system 21S may extend up to 102″ in width which is the maximum legal width of vehicles permitted in the United States and most other countries. The width of lift system 21S may vary as do the legal widths of vehicles in other countries.

FIG. 11ga is a partial top view of guide rail cart 104 mounted on guide rails 103a and 103b which is moved back and forth on guide rails via screw shaft drive assembly 111. As shown, motor 121 is equipped with drive gear 125 and interfaced with axle gear 126 on drive shaft 135 which is connected to right angle gear boxes 134a and 134b. Notice that gear motor shafts 139a and 139b from right angle gear boxes 134a and 134b respectively are connected to universal shaft couplers 136a and 136b to allow a change of angle and movement away from the plane of gear box shafts 139a and 139b respectively. As screw shafts 137a and 136b rotate, shaft nuts 138a and 138b, which are fixed to guide rail cart 104, will allow guide rail cart 104 to move. Screw shaft drive assembly 111 may be used as an option instead of a chain powered system or other drive systems on lift system 21S.

FIG. 11h is a partial top view of lift posts 21Pa and 21Pb equipped with motor 121a and drive axle 118a. As shown, drive axle 118a is equipped with sprockets 116e and 116g while axle 119b that equipped with sprockets 116f and 116h which hold chains 117c and 117d in place. Similar in design as to the drive system shown in FIG. 11g, as motor operates in forward and backwards directions, chains 117c and 117d move back and forth which control the movement of lift container 27 (not shown) as it is secured to chain connectors 120a and 120b and lift tracks 23a and 23b. Also notice proximity switches 123a and 123b attached to lift posts 21Pa and 21Pb respectively to stop the operation of drive motor 121a and movement of chains 117c and 117d. As lift posts 21Pa and 21Pb transition from a horizontal position to a mostly vertical position, all motion of lift posts 21Pa and 21Pb will stop if a interference such as guard rail, wheel barrow, person or other objects are in the way. Limit switches 79e, 79f, 79g and 79h are attached to lift tracks 23a and 23b to limit the motion of lift container 27. It is anticipated that more limit switches 79 and proximity switches 123 will be located on lift system 21S to control motion. One of the benefits of using a hydraulic pump and hydraulic components is the ready availability to use pressure and flow control devices to change power and speed settings.

FIG. 11i is a partial top view of lift system 21S that also uses a drive system that is very similar to what's shown in FIGS. 11H and 11i. Drive motor 121 is interfaced with drive axle 118 via drive gear 125 and drive axle gear 126 to operate the movement of guide rail base plates 102a and 102b on dump body 31 (not shown). As shown, bearings 124a and 124c hold drive axle 118 to pipe rail 95a and 96b as as well as bearings 124b and 124d holding axle 119 between pipe rails 96a and 96b. Chain 117b is attached to to sprockets 116c and 116d and connected to guide rail base plate 102b via chain connector 120a while chain 117a is attached to sprockets 116a and 116b and connected to guide rail base plate 102a. To control the lateral movement of lift system 21S, limit switches 79i and 79j are secured to pipe rail 96a. When proximity switches 124a, 124b, 124c and 124d are activated, motor 121 will stop. Limit switches 79 may be used in place of proximity switches 124.

FIG. 11j is an end view of truck 20 with dump body 31 showing lift system 21S using lift tracks 23a and 23b (opposite side) that are straight (not cane shaped) equipped with L shaped platform 128 secured to lift tracks 72a and 72b (opposite side) via rollers 44a and 44b as well as 44c and 44d (opposite side). L shaped platform 128 is equipped with proximity switches 123c and 12d while lift tracks 72a and 72b (opposite side) are equipped with proximity switches 123a and 123e and 123b and 123f (opposite side). In this configuration, lift system 21S may handle non-bulk materials such as bags of sand 127a, 127b and 127c and/or other piece goods. As shown, to keep bags of sand 127a, 127b and 127c from falling over as they transition from moving vertically to horizontally, sandwich plate 129 is fastened and locked in place on L shaped platform.

FIG. 11k is an end view of lift system 21S equipped with straight lift tracks 23a and 23b (not shown) equipped with lift container 29 that provides a dumping motion operated via lift container axle 29X and hydraulic cylinder 25a. Hydraulic cylinder 25a is mounted on cylinder base plate 130 and attached to any combination of track styles (cane shape vs. straight and lift container configuration may be used with lift system 21S. Lift containers (29) may be perforated with holes so as not allow water to collect in them.

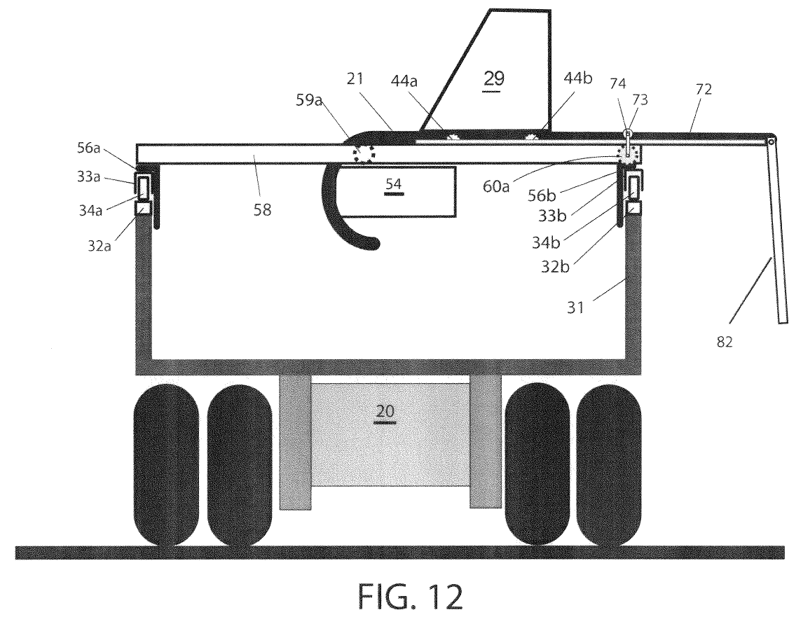

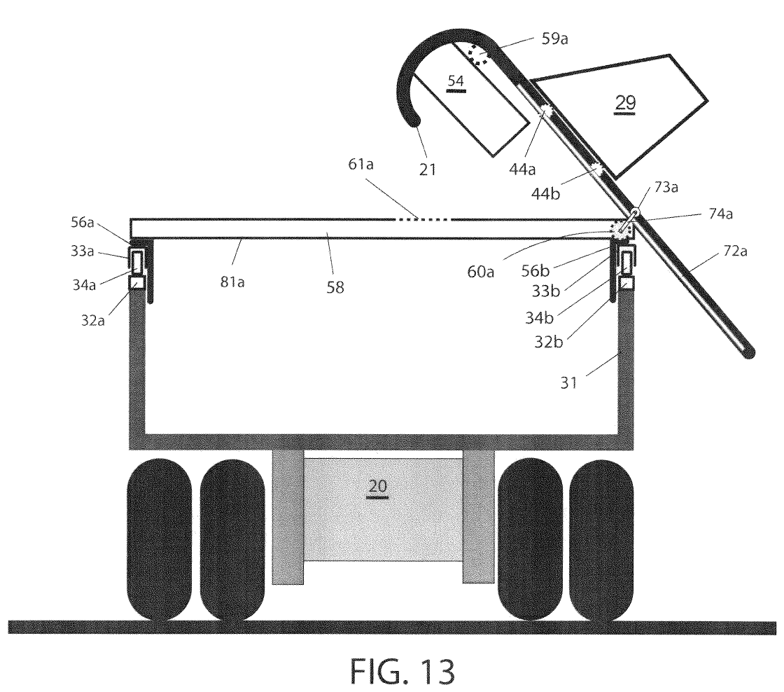

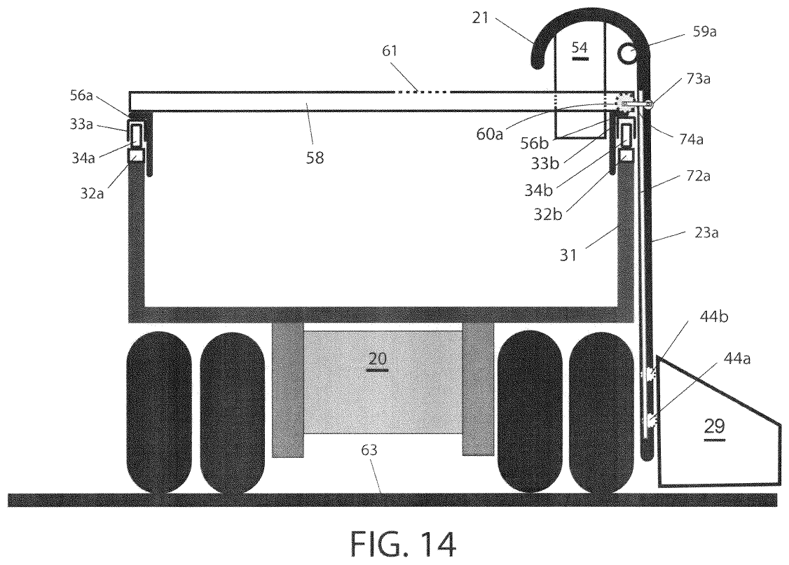

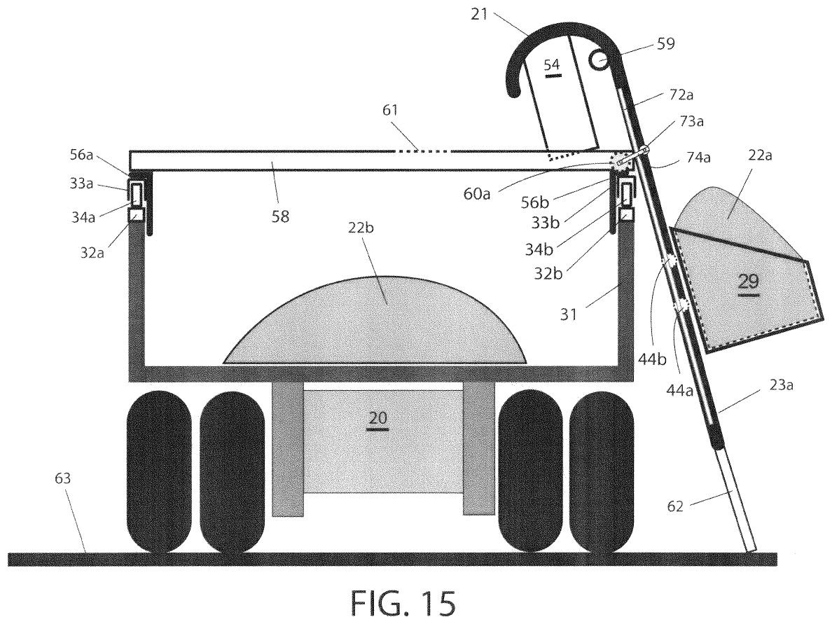

FIGS. 11, 12, 13, 14 and 15 are end views of the lift assembly 21 mounted on the dump body 31 via a trolley frame 58 which is secured in a horizontal position to the top rails 32a and 32b whereby the lift assembly 21 and the trolley frame 58 do not extend beyond width of the dump body 31. In FIG. 11, the lift assembly 21 is in its' stowed position for transport secured to the trolley frame 58 via trolley wheels 59a and 59b (not shown and fixed rollers 60 and 60b (not shown). Trolley frame 58 is equipped with collar brackets 56a and 56b which keep trolley frame 58 and lift assembly 21 centered between top rails 32a and 32b of dump body 31. Also shown are wheel brackets 33a and 33b, each equipped with wheels 34a and 34b respectively that are fixed to trolley frame 58. The wheels 34a and 34b allow the trolley frame 58 and the lift assembly 21 to move from the front of the dump body 31 to the back end of the dump body 31. The wheels 34a and 34b may be powered with small 115V or 12V motors for automatic and/or powered movement as the dump body 31 is filled with the lift assembly 21 from one end to the other end to create a level fill. The control enclosure 54 is fixed to the lift assembly 21 via the lift tracks 23a and 23b (not shown). The lift container 29 is attached to the lift tracks 23a and 23b (not shown) and/or the cross supports 24a, 24b and 24c (not shown). The lift container 29, which may be rigid as shown or collapsible, is attached to the lift frame tracks 23a and 23b (not shown) via a set of rollers 44a and 44b and a roller beam 43. For some applications, the wheels 44a, 44b and 44c and 44d (not shown) may be secured directly to the lift container 29. In FIG. 12, the operator has removed assembly the lift lock 54 (not shown) that holds the lift assembly 21 to the trolley frame 54 and has rolled the lift assembly 21 across the trolley frame 58 via a swivel pole handle 82. For the majority of applications, the lift assembly 21 may be moved back and forth on the trolley frame 58 via a linear actuator 80 (not shown) and the cable and pulley assembly 75 (not shown) contained in the control enclosure 54. In FIG. 13, as the lift frame 21 is pulled further along the trolley frame 58, a set of trolley wheels 59a and 59b are able to move upward via a set of trolley wheel openings 61a and 61b. The lift assembly 21 remains connected to the trolley frame 58 via fixed the rollers 60a and 60b (not shown) as a set of roller connectors 74a and 74b (not shown) in conjunction with the side rollers 73a and 73a (not shown) and as they remain engaged with the side rails 72a and 72b (not shown) fixed to the lift tracks 23a and 23b (not shown). In FIG. 14, the lift frame 21 has been lowered to the ground 63 on the passenger side of the truck 20 (not shown). The lift tracks 23a and 23b remain connected to the trolley frame 58 and the dump body 31 via the side rails 72a and 72b which are contained between the fixed rollers 60a and 60b (not shown), the side rollers 73a and 73b (not shown) and the roller connectors 74a and 74b (not shown). In FIG. 15, a set of track extensions 62a and 62b, which may be adjustable in height) have been temporarily attached to the lift tracks 23a and 23b so that top end of the lift assembly 21 provides a higher and more centered position over the dump body 31 for the lift container 29 to provide a more balanced and centered load of the grass clippings 22b or other bulk materials within the dump container 31. As the lift container 29 is moved up the lift assembly 21 with another load of the grass clippings 22a, even with the lift tracks 23a and 23b (not shown) angled and positioned higher on the dump body 31, the lift assembly 21 remains secured to the dump body 31 via a fixed roller 70 on the trolley frame 58 with the side rollers 73a and 73b (not shown) and the roller connectors 74a and 74b (not shown) containing the roller connectors 74a and 74b (not shown).

FIGS. 16 and 17 are top views of the trolley frame 58 equipped with the lift assembly 21 stowed in different locations on the dump container 31. In FIG. 16, the trolley frame 58 and the lift assembly 21 are locked in position via the lift assembly lock 53 (not shown) while the truck 20 (not shown) is parked and/or moving. The collar bracket 56a on the trolley frame 58 is equipped with the wheels 34a and 34c while the collar bracket 56b on the trolley frame 58 is equipped with the wheels 34b and 34d which are used for moving the trolley frame 58 along the top rails 32a and 32b of the dump body 31. The wheels 34a, 34b, 34c and 34d or connected to motorized chain (not shown) or the cable/pulley system 75 (not shown). To comply with certain traffic and highway laws around the world which limit the width of a highway vehicles, the trolley frame 58 and the lift assembly 21 remain within the width of the dump body 31. In FIG. 17, the trolley frame 58 and the lift assembly 21 have been unlocked from their stowed position and moved along the top rails 32a and 32b towards the back end of the dump body 31 via the wheels 34a, 34b, 34c and 34d.

FIGS. 18 and 19 are top views of the lift assembly 21 with the control enclosure 54 with the linear actuator 80 installed to move a set of cables 7A and 7B secured to the lift container 29 up and down the lift tracks 23a and 23b via the cable and pulley assembly 75. In FIG. 18, the linear actuator 80 is equipped with a load cell 27 to act as a shut off switch in case the lift container 29 is overloaded and too heavy for the lift assembly 21 to be operated safely. As shown, to reduce the load and keep the travel distance relatively short a linear actuator extension 80E of the linear actuator 80, the cable and pulley system 75 are designed as a block and tackle type of arrangement. In this configuration, the lift container 29 will be moved up and down the lift tracks 23a and 23b via the cables 7A and 7B to provide an even and balanced lifting and lowering motion of the lift container 29 in case the lift container 29 has an uneven load and may tip to one side as if a single cable were used. The end of the cable 7A are equipped with a set of cable connectors 84a and 84c which will attach to top end of the lift container 29. The cable 7A is secured around a set of single pulley's 70a and 70c before it is secured to a set of double pulley's 70e and 70f for placement around a double moving pulley 69a, the double pulley 70n and then back around the double moving pulley 69b to the double pulley's 70g and 70i to a set of single pulley's 70k and 70L to the cable connector 84c. The cable 7B is first attached to the single pulleys 70b and 70d before being attached to the double pulleys 70e and 70f and then to the double movable pulley 69a, to the double pulley 70n and back to the movable double pulley 69b before it extends to out of the control enclosure 54 to the double pulleys 70g and 70i to the single pulleys 70j and 70m ending at the cable connector 84d. A mechanical advantage and reduced travel extension of the linear actuator 80 is established as evidenced by a 4 to 1 lifting ratio in both weight and distance. For example, as compared with a cable and pulley system with no type of block and tackle arrangement which equal a 1 to 1 ratio, for 1 inch of travel via the linear actuator extension 80E movement, 4 inches of cable travel is provided. Assuming the length of lift tracks 23a and 23b are 8 feet long, the liner actuator extension 80E will only need to move 2 feet instead of 8 feet. Also, the load in the lift container 29 is 4 times lighter resulting in the use of the less powerful linear actuator 80 actuator. In FIG. 19, the linear actuator extension 80E has been fully retracted enabling the lift container 29 to move up to the top lift tracks 23a and 23b.

FIG. 20 is a top view of the lift assembly 21 equipped with the control enclosure 54, the lift tracks 23a and 23b, the lift container 29 and the single cable 7. For some applications which may be designed to carry much heavier loads and/or a larger capacity, the lift container 29 may be made up to 6 feet wide and equipped with a lockable swivel mount 93 (not shown) to take up less space on the lift assembly 21 when stowed for transport.

FIG. 21 is a top view of the control enclosure 58 using the single cable 7 in conjunction with the cable and pulley assembly 75, the linear actuator 80, a load cell 27 and a scale 89. The control enclosure 54 is also equipped with a weight display 86 and an adjustable weight control 87 for the load cell 27 as well as an on/off button 90, an E-Stop button 88 and an up/down switch 91 which may be momentary switches for safer operation.

I claim:

1. A loading apparatus configured to be mounted on a dump body (31) of a vehicle (20) for handling, lifting, and dumping bulk materials comprising:
a first guide rail (103a) and a second guide rail (103b) having lengths sized to span a distance between a first side wall (31a) and a second side wall (31b) of a dump body (31) of a vehicle (20);
a guide rail cart (104) configured to secure the first guide rail (103a) and the second guide rail (103b) in a spaced apart and parallel relationship;
a first lift frame post (21Pa) configured to be secured parallel to and proximate the first guide rail (103a) via the guide rail cart (104), and a second lift frame post (21Pb) configured to be secured parallel to and proximate the second guide rail (103b) via the guide rail cart (104);
a first trolley frame assembly (100a) configured to be secured to a first end of the first guide rail (103a) for translating along the first side wall (31a);
a second trolley frame assembly (100b) configured to be secured to a first end of the second guide rail (103b) for translating along the first side wall (31a);
a third trolley frame assembly (100c) configured to be secured to a second end of the first guide rail (103a) for translating along the second side wall (31b); and
a fourth trolley frame assembly (100d) configured to be secured to a second end of the first guide rail (103a) for translating along the second side wall (31b);
whereby bulk materials loaded within a lift container (29) secured to the first lift frame post (21Pa) and second lift frame post (21Pb) can be lifted by the first lift frame post and second lift frame post by rolling along the first guide rail (103a) and second guide rail (103b) respectively, can be translated laterally along dump body (31) by the trolley frame assemblies (100), and then can be dumped into the dump body.

2. The loading apparatus of claim 1, the guide rail cart (104) comprising:
a first cart axle (110a) securable to the first lift frame post (21Pa);
a second cart axle (110b) securable to the second lift frame post (21Pb);
a first cart roller assembly (105a) and a third cart roller assembly (105c) rollingly secured to the first guide rail (103a); and
a second cart roller assembly (105b) and a fourth cart roller assembly (105d) rollingly secured to the second guide rail (103b).

3. The loading apparatus of claim 2, further comprising:
a connector (115) for securing the first trolley frame assembly (100a) and the second trolley frame assembly (100b) together;
at least one chain connector (120a, 120b) securable to the rail cart (104);
a drive axle (118) securable to the first guide rail (103a) and the second guide rail (103b);
a freewheeling axle (119);
at least one chain (117a, 117b) configured to be in operative communication with the drive axle (118) and the freewheeling axle (119); and
a motor (121),
whereby bulk materials loaded within a lift container (29) secured to the first lift frame post (21Pa) and second lift frame post (21Pb) can be lifted by operation of the motor (121).

4. The loading apparatus of claim 3, further comprising:
a first lift track (23a) securable to the first lift frame post (21Pa); and
a second lift track (23b) securable to the second lift frame post (21Pb).

5. The loading apparatus of claim 4, further comprising at one limit switch (79e, 79f, 79g, 79h) securable to the first lift track (23a) and/or the second lift track (23b).

6. The loading apparatus of claim 3, further comprising:
at least one drive axle sprocket (116a, 116c) securable to the drive axle (118) and the at least one chain (117a, 117b);
at least one freewheeling axle sprocket (116b, 166d) securable to the freewheeling axle (119); and
at least one chain frame (114a, 114b).

7. The loading apparatus of claim 6, further comprising at least one limit switch (79a, 79b, 79c, 79d) securable to the first guide rail (103a) and/or the second guide rail (103b).

8. The loading apparatus of claim 1, further comprising:
a first dump body base plate (94a) securable to the first dump body side wall (31a);
a first end plate (95a) securable perpendicularly proximate a first end of the first dump body base plate (94a);
a second end plate (95b) securable perpendicularly proximate a second end of the first dump body base plate (94a);
a first roller pipe (96a) removably securable between the first end plate (95a) and the second end plate (95b);
a second dump body base plate (94b) securable to the second dump body side wall (31b);
a third end plate (95c) securable perpendicularly proximate a first end of the second dump body base plate (94b);
a fourth end plate (95d) securable perpendicularly proximate a second end of the second dump body base plate (94b);
a second roller pipe (96b) removably securable between the third end plate (95c) and the fourth end plate (95d).

9. The loading apparatus of claim 8,
the first trolley frame assembly (100a) comprising a first top roller (98a) rotatably secured to the first trolley frame assembly and configured to roll on the first roller pipe (96a);
the second trolley frame assembly (100b) comprising a second top roller (98c) rotatably secured to the second trolley frame assembly and configured to roll on the first roller pipe (96a);
the third trolley frame assembly (100c) comprising a third top roller (98b) rotatably secured to the third trolley frame assembly and configured to roll on the second roller pipe (96b);
the fourth trolley frame assembly (100d) comprising a fourth top roller (98d) rotatably secured to the fourth trolley frame assembly and configured to roll on the second roller pipe (96b).

10. The loading apparatus of claim 9,
the first trolley frame assembly (100a) further comprising a first bottom roller (97a) rotatably secured to the first trolley frame assembly beneath the first top roller (98a) and configured to roll on the first roller pipe (96a);
the second trolley frame assembly (100b) further comprising a second bottom roller (97c) rotatably secured to the second trolley frame assembly beneath the second top roller (98c) and configured to roll on the first roller pipe (96a);
the third trolley frame assembly (100c) further comprising a third bottom roller (97b) rotatably secured to the third trolley frame assembly beneath the third top roller (98b) and configured to roll on the second roller pipe (96b);
the fourth trolley frame assembly (100d) further comprising a fourth bottom roller (97d) rotatably secured to the fourth trolley frame assembly beneath the fourth top roller (98d) and configured to roll on the second roller pipe (96b).

11. The loading apparatus of claim 10,
the first trolley frame assembly (100a) comprising:
first opposing side flanges (101a, 101b);
an upper axle (99a) securable to the opposing side flanges (101a, 101b) for holding the top roller (98a); and
a lower axle (99b) securable to the first opposing side flanges (101a, 101b) for holding the bottom roller (97a); and
the third trolley frame assembly (100c) comprising:
second opposing flanges (101c, 101d);
an upper axle (99c) securable to the second opposing side flanges (101a, 101b) for holding the top roller (98b); and
a lower axle (99d) securable to the second opposing side flanges (101a, 101b) for holding the bottom roller (97b).

12. The loading apparatus of claim 8, further comprising:
a first base plate (102a) securable to the first guide rail (103a) first end and the second guide rail (103b) first end;
a second base plate (102b) securable to the first guide rail (103a) second end and second guide rail (103b) second end;
a drive axle (118);
a freewheeling axle (119);
at least one chain (117a, 117b) operatively connectable to the drive axle (118), freewheeling axle (119), the first base plate (102a), and the second base plate (102b); and
a drive motor (121) operatively connectable to the drive axle (118),
whereby the guide rails (103a, 103b) and therefore the lift container (29) can be moved to different positions over the dump body (31) by operating the drive motor (121).

13. The loading apparatus of claim 12, further comprising:
a first chain connector (120b) attachable to the first base plate (102a);
a second chain connector (120a) attachable to the second base plate (102b);
the drive axle (118) configured to be rotatably secured between a first bearing (124a) proximate the first end plate (95a) and a third bearing (124c) proximate the third end plate (95c);
the freewheeling axle (119) configured to be rotatably secured between a second bearing (124b) proximate the second end plate (95b) and a fourth bearing (95d) proximate the fourth end plate (95d);
a first sprocket (116a) securable on the drive axle (118) proximate the first bearing (124a);
a second sprocket (116b) securable on the freewheeling axle (119) proximate the second bearing (124b);
a third sprocket (116c) securable on the drive axle (118) proximate the third bearing (124c); and
a fourth sprocket (116d) securable on the freewheeling axle (119) proximate the fourth bearing (124d).

14. The loading apparatus of claim 13; further comprising:
a drive gear (125) configured to be in operative communication with the drive motor (121); and
a drive axle gear (126) securable to the drive axle (118) and configured to be in operative communication with the drive gear (125).

15. The loading apparatus of claim 12, further comprising limit switches (79i, 79j) securable to the first pipe rail (96a).

16. The loading apparatus of claim 1, further comprising:
a first lift frame roller assembly (74Xa) securable proximate the first guide rail (103a) second end, the first lift frame roller assembly comprising:
a first fixed roller (60a);
a first side roller (73a); and
a first roller connector (74a) connecting axes of the first fixed roller and the first side roller for guiding the first lift frame post (21Pa); and
a second lift frame roller assembly (74Xb) securable proximate the second guide rail (103b) second end, the second lift frame roller assembly comprising:
a second fixed roller (60b);
a second side roller (73b); and
a second roller connector (74b) connecting axes of the second fixed roller and the second side roller for guiding the second lift frame post (21Pb).

17. The loading apparatus of claim 16, further comprising:
a first lift track (72a) configured to rollingly engage the first fixed roller (60a) and first side roller (73a);
a second lift track (72b) configured to rollingly engage the second fixed roller (60b) and second side roller (73b); and
an L-shaped platform (128) configured to engage in a sliding relationship with the first and second lift tracks,
whereby the loading apparatus lifts and dumps bags of sand (127a, 127b, 127c) or other bulk materials by lifting them with the L-shaped platform.

18. The loading apparatus of claim 17, further comprising:
a sandwich plate (129) securable to the L-shaped platform (128) to keep the bags of sand (127a, 127b, 127c) from falling over when the apparatus is in operation.

19. The loading apparatus of claim 17, further comprising:
at least one proximity switch (123c, 123d) securable to the L-shaped platform (128); and
at least one proximity switch (123a, 123e) securable to the first lift track (72a); and
at least one proximity switch (123b, 123f) securable to the second lift track (72b).

20. The loading apparatus of claim 1, further comprising:
a first chain roller bracket (132a) securable to the first guide rail (103a), the first chain roller bracket comprising:
a first freewheeling sprocket (131a); and
a second freewheeling sprocket (131b); and
a second chain roller bracket (132b) securable to the second guide rail (103b), the second roller bracket comprising:
a third freewheeling sprocket (131c); and
a fourth freewheeling sprocket (131d).

21. The loading apparatus of claim 20,
the first chain roller bracket (132a) further comprising a first chain guard (133a); and
the second chain roller bracket (132b) further comprising a second chain guard (133b).

22. The loading apparatus of claim 1, further comprising:
at least one shaft nut (138a, 138b) securable to the guide rail cart (104);
at least one screw shaft (137a, 137b) sized to operatively engage the at least one shaft nut;
at least one universal shaft coupler (136a, 136b) securable to the at least one screw shaft;
at least one right angle gear box (134a, 134b) configured to be operatively coupled to the at least one universal shaft coupler;
a drive shaft (135) configured to be operatively coupled to the at least one right angle gear box; and
a motor (121) configured to be operatively coupled to the drive shaft.

23. The loading apparatus of claim 22, further comprising:
at least one limit switch (79a, 79b, 79c, 79d) securable to the first guide rail (103a) and/or the second guide rail (103b).

24. The loading apparatus of claim 4, further comprising:
a lift container axle (29X) securable to the first lift track (23a) and the second lift track (23b);
a lift container (29) rotatably securable to the lift container axle; and
a hydraulic cylinder (25a) securable to the lift container for facilitating dumping bulk materials from the lift container.
